(19) United States
(12) Patent Application Publication
(10) Pub. No.: US 2023/0249993 A1
(43) Pub. Date: Aug. 10, 2023

(54) APPARATUS AND METHODS FOR TREATING WATER FOR REMOVAL OF PFAS

(71) Applicant: AVANTech, LLC, Columbia, SC (US)

(72) Inventors: Michael F. REED, Columbia, SC (US); James L. BRAUN, Blythewood, SC (US); Tracy A. BARKER, Columbia, SC (US)

(21) Appl. No.: 18/108,240

(22) Filed: Feb. 10, 2023

Related U.S. Application Data
(60) Provisional application No. 63/308,628, filed on Feb. 10, 2022.

(51) Int. Cl. C02F 1/42; C02F 1/00

(52) U.S. Cl. CPC C02F 1/42; C02F 1/004; C02F 2001/422; C02F 2101/36

(57) ABSTRACT

Apparatus for treating water including PFAS includes influent piping adapted to conduct untreated water from an untreated water source. A first process vessel is fluidly coupled to the influent piping to receive the untreated water. First transfer piping is adapted to conduct first vessel processed water from the first process vessel. A second process vessel is coupled to the first transfer piping to receive the first vessel processed water. An ion exchange injection mechanism is adapted to supply ion exchange material to the second process vessel. Second transfer piping is adapted to conduct second vessel processed water from the second process vessel.

### PRIORITY CLAIM

This application is based upon and claims the benefit of U.S. provisional application Ser. no. 63/308,628, filed Feb. 10, 2022, which is incorporated fully herein by reference for all purposes.

### FIELD OF THE INVENTION

Embodiments of this invention relate to removal of PFAS and related compounds from water.

### BACKGROUND OF THE INVENTION

Per- and polyfluorinated substances (PFAS) have previously been referred to as perfluorochemicals (PFCs). PFAS are a group of chemicals used to make fluoropolymer coatings and products that resist heat, oil, stains, grease, and water. Fluoropolymer coatings are used in products such as clothing, furniture, adhesives, food packaging, heat-resistant non-stick cooking surfaces, and electrical wire insulation. Many chemicals in this group, including perfluorooctane sulfonic acid (PFOS) and perfluorooctanoic acid (PFOA), have been a concern because: (i) they do not break down in the environment; (ii) they move through soils and enter drinking water sources; and (iii) they build up (bioaccumulate) in fish and wildlife. PFAS have been found in rivers and lakes and in many types of animals on land and in the water.

Current treatment options for PFAS are limited and expensive. Treatment options include mainly granular activated carbon material or other specialty absorbents. An example of an existing system for PFAS removal is shown and described in U.S. Pub. No. 2021/0322951A1.

### SUMMARY OF THE INVENTION

Ion exchange material is utilized for extraction of contaminants such as PFAS. This ion exchange (IX) material may be provided in a bead form or in a powder form (as powdered ion exchange (PIX) material). Suitable IX material may be an anion strong base ion exchange media. The IX material may be manufactured as a perchlorate type IX resin and then ground to the desired particle size.

Additionally, various apparatus and methods may be utilized to treat untreated liquid with the IX material. The IX material, apparatus, and methods described herein have significantly improved efficiency of contaminant removal compared to other approaches.

Additionally, embodiments are contemplated herein that may include one or more vessels, separators, mixers, and other processing components to reduce the content of PFAS and other contaminants from untreated liquid. Additional vessels and other components may be used to achieve a further reduction in the content of PFAS or other contaminants. Additionally, in some embodiments where two or more vessels are used, fresh PIX material or fresh IX material in bead form may be provided only at a lag vessel, and PIX material or IX material in bead form may be fed back (recycled) to a lead vessel. At the lead vessel, the IX material may interact with higher concentrations of the contaminant. By recycling the IX material, this IX material may be used more efficiently. Systems may allow for a high capacity of water to be treated, and the operating costs of systems may be low due to the efficient usage of IX material and due to low costs of disposal.

One aspect of the present invention provides an apparatus for treating water including PFAS. The apparatus according to this aspect comprises influent piping adapted to conduct untreated water from an untreated water source. A first process vessel is fluidly coupled to the influent piping to receive the untreated water. First transfer piping is adapted to conduct first vessel processed water from the first process vessel. A second process vessel is coupled to the first transfer piping to receive the first vessel processed water. An ion exchange injection mechanism is adapted to supply ion exchange (IX) material to the second process vessel. Second transfer piping is adapted to conduct second vessel processed water from the second process vessel.

Some exemplary embodiments comprise feedback piping adapted to supply used ion exchange material from the second process vessel to the first process vessel. According to some exemplary embodiments, the ion exchange injection mechanism injects powder ion exchange material into the second process vessel. According to some exemplary embodiments, the ion exchange injection mechanism injects bead ion exchange material into the second process vessel. According to some exemplary embodiments, at least one of the first process vessel and the second process vessel includes a mixing mechanism. According to some exemplary embodiments, a separator may be located along the second transfer piping downstream of the second process vessel. According to some exemplary embodiments, IX discharge piping may be fluidly coupled to the first process vessel to facilitate removal of spent IX material therefrom. According to some exemplary embodiments, a third process vessel may be fluidly coupled to the second transfer piping downstream of the second process vessel. According to some exemplary embodiments, the ion exchange injection mechanism may be adapted to introduce ion exchange material into the first transfer piping. According to some exemplary embodiments, first and second filters may be associated with the first transfer piping and the second transfer piping, respectively.

Another aspect of the present invention provides an apparatus for treating water including PFAS. The apparatus according to this aspect comprises influent piping adapted to conduct untreated water from an untreated water source. A first process vessel is fluidly coupled to the influent piping to receive the untreated water. First transfer piping is adapted to conduct first vessel processed water from the first process vessel. A second process vessel is coupled to the first transfer piping to receive the first vessel processed water. An ion exchange injection mechanism is adapted to supply ion exchange (IX) material to the second process vessel. Second transfer piping is adapted to conduct second vessel processed water from the second process vessel. Feedback piping is adapted to supply used ion exchange material from the second process vessel to the first process vessel. At least one of the first process vessel and the second process vessel includes a mixing mechanism.

A further aspect of the present invention provides a method of treating liquid containing PFAS. One step of the method involves feeding untreated liquid into a first process vessel. The untreated liquid is processed via first vessel IX material in the first process vessel to produce first vessel processed liquid. The first vessel processed liquid is transferred from the first process vessel to a second process vessel. The first vessel processed liquid is processed via second vessel IX material in the second process vessel to produce second vessel processed liquid. At least a portion of the second vessel IX material is fed back (recycled) to the first process vessel so as to contribute to the first vessel IX material. The second vessel processed liquid is transferred from the second process vessel.

Further areas of applicability of the present invention will become apparent from the detailed description provided hereinafter. It should be understood that the detailed description and specific examples, while indicating preferred embodiments of the invention, are intended for purposes of illustration only and are not intended to limit the scope of the invention.

### BRIEF DESCRIPTION OF THE DRAWINGS

Embodiments of the present invention will become more fully understood from the detailed description and the accompanying drawings, which are not necessarily to scale, wherein:

FIG. 1A is a diagrammatic representation of an apparatus for removal of PFAS in liquid having a lead vessel and a lag vessel, in accordance with an embodiment of the present invention.

FIG. 1B is a diagrammatic representation of an apparatus for removal of PFAS in liquid having a lead vessel, a lag vessel, and a polish vessel, in accordance with an embodiment of the present invention.

FIG. 2 is a diagrammatic representation of another apparatus utilizing a lead vessel and a lag vessel without filters therein, in accordance with an embodiment of the present invention.

FIG. 3 is a diagrammatic representation of another apparatus utilizing a mixer, in accordance with an embodiment of the present invention.

FIG. 4 is a diagrammatic representation of another apparatus utilizing a separator, in accordance with an embodiment of the present invention.

FIG. 5 is a flow chart showing some aspects of methodology in accordance with aspects of the present invention.

### DESCRIPTION OF THE PREFERRED EMBODIMENTS

Some example embodiments now will be described more fully hereinafter with reference to the accompanying drawings, in which some, but not all example embodiments are shown. For instance, features illustrated or described as part of one embodiment may be used on another embodiment to yield a still further embodiment. Thus, it is intended that the present invention covers such modifications and variations as come within the scope of the appended claims and their equivalents. In addition, the examples described and illustrated herein should not be construed as being limiting as to the scope, applicability, or configuration of the present disclosure. Statements herein that a component is “attached” to another component (or words having similar meaning) are intended to indicate that these components are directly or indirectly attached together unless stated otherwise.

Further, the term “or” as used herein is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used herein should generally be construed to mean “one or more” unless specified otherwise or clear from the context to be directed to a singular form. Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in,” “at,” and/or “on,” unless the context clearly indicates otherwise. The phrase “in one embodiment,” as used herein does not necessarily refer to the same embodiment, although it may. Moreover, features of one embodiment may be incorporated into other embodiments to yield still further embodiments.

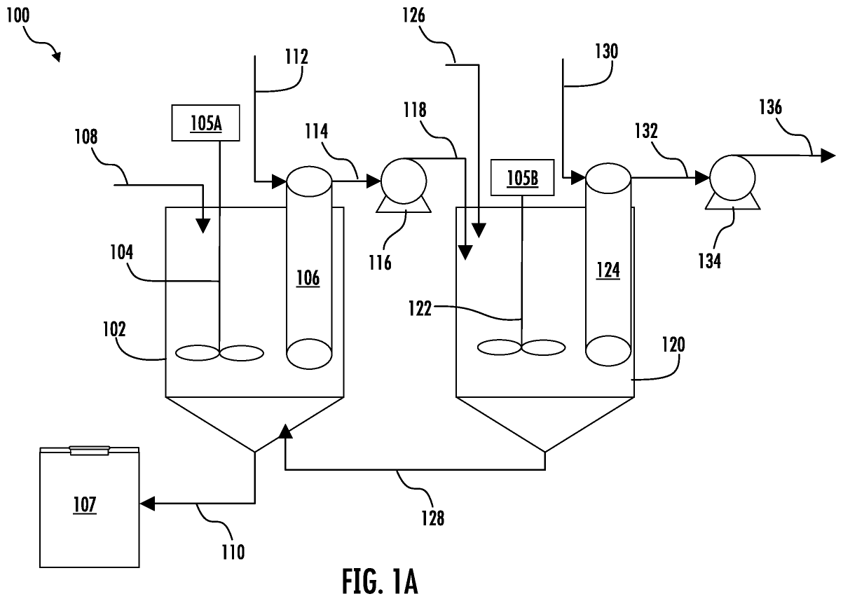

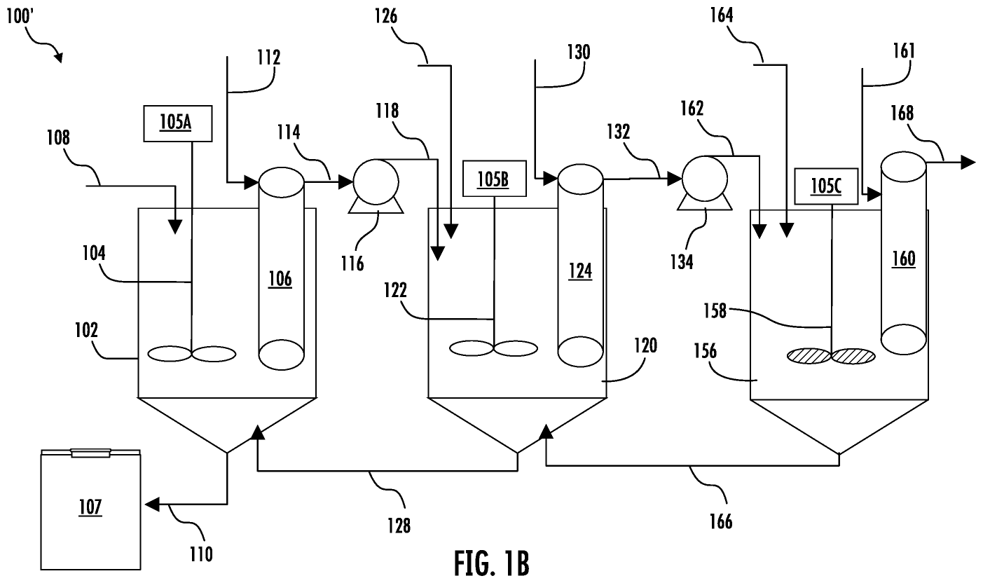

FIG. 1A is diagrammatic representation of an apparatus 100 in accordance with an embodiment of the present invention. Untreated liquid, e.g., untreated water having PFAS to be removed, may be inserted to a lead vessel 102 via line (piping) 108. (As used herein, “untreated” simply means liquid that has not been treated according to the present invention.) Other contaminants, such as perchlorate, pertechnetate, iodide, iodate, other oxyanions, and hydrophobic anions, may also be present in addition to or in lieu of PFAS. In an example, the contaminant material(s) may be provided at 100,000 parts per trillion (PPT). The lead vessel 102 may be an atmospheric mixing vessel such as a continuously stirred tank reactor (CSTR) having a mixing impeller 104. The mixing impeller 104 may be driven by a motor 105A or the like. In some embodiments, the mixing impeller 104 may be continuously active so that it continuously mixes material in the lead vessel 102.

The lead vessel 102 may also have a filter 106. Filtrate material passing through the filter 106 may flow to line 114 via a pump 116. To ensure that filtered material does not clog the filter 106, air, water, or another fluid may be provided (e.g., pulsed) via line 112 to backwash filtered material from the filter 106. While the filter 106 is illustrated in FIG. 1A as being provided in the lead vessel 102, the filter 106 may be associated with but outside of (i.e., downstream of) the lead vessel 102 in other embodiments. The filter 106 and other filters described herein may comprise a suitable polypropylene backwashable filter in some embodiments, but other suitable filters may also be utilized.

After IX material has been used and/or recycled, this IX material may eventually become exhausted. The exhausted (“spent”) material must be safely disposed, and special disposal requirements may apply. Such spent material, for example, may be sent to waste container(s) 107 or other disposal units such as via line 110. Containers 107 or other disposal units preferably seal spent material therein with little to no leaching. Various embodiments are contemplated in which spent material may be allowed to flow continuously through line 110, spent material may be allowed to flow through line 110 at regularly scheduled intervals, or spent material may be allowed to flow through line 110 only once certain conditions are met.

Filtrate material may be transported to the lag vessel 120 via line 114 and line 118 at the inlet and outlet of the pump 116, respectively. It will be appreciated that the lag vessel 120 should have a lower concentration of contaminants than the lead vessel 102. For example, contaminant material may initially be provided to lag vessel 120 at about 2,000 PPT. Through the use of the lead vessel 102 and its associated features, the concentration of contaminant material provided to lag vessel 120 may be approximately at least 90% lower than the concentration of contaminant material in line 108. For example, the concentration may be at least 93% lower, at least 95% lower, or at least 98% lower. Similar to the lead vessel 102, the lag vessel 120 may have a mixing impeller 122 driven by a motor 105B.

A desired concentration of IX material may be injected into the lag vessel 120 such as via the line 126. For example, IX material may be continuously injected into the lag vessel 120 in some embodiments. In this regard, IX material may be injected into the lag vessel 120 as a fresh powder slurry in some embodiments. In other embodiments, the IX material may be provided in bead form in lieu of or in addition to PIX, e.g., utilizing an ion exchange column. As one skilled in the art will appreciate, IX “beads” are much larger than particles of PIX (e.g., 10 times larger). In this regard, beads might have an average size of 400-800 microns, with about 600 microns being typical. Powder may have an average particle size falling in a range of about 120 microns down to about 10 microns minimum.

After the system has been initiated, the concentration of IX material in the lag vessel 120 may be approximately 100 milligrams per liter, and the concentration of IX material in the lead vessel 102 may be approximately 1000 milligrams per liter in some embodiments. However, other concentrations may be used as necessary or desired. The desired concentrations of IX material may be obtained by adjusting the amount of fresh IX material that is injected.

In some embodiments, such as the embodiment illustrated in FIG. 1A, fresh IX material is injected only into the lag vessel 120, and only recycled IX material is provided to the lead vessel 102 via line 128. However, in other embodiments, a fresh supply of IX material may be provided to the lead vessel 102 via an additional line. Recycled IX material may be material that is fed back from the lag vessel 120. By such recycling, this IX material may be more thoroughly and efficiently used to remove contaminants from the untreated water.

A filter 124 may be associated with lag vessel 120. To ensure that material does not clog the filter 124, air, water, or another fluid may be provided via line 130 (e.g., pulsed) to backwash material from the filter 124. While the filter 124 is illustrated as being provided in the lag vessel 120 in FIG. 1A, the filter 124 may be associated with but outside of (i.e., downstream of) the lag vessel 120 in other embodiments.

Filtrate material passing through the filter 124 of the lag vessel 120 may be drawn from the filter 124 through line 132 (via pump 134) to line 136 so that it may be provided as effluent discharge material. It will be appreciated that the effluent discharge material should have a lower concentration of contaminants than the material entering lag vessel 120. For example, as noted above, contaminant material may be present at about 2,000 PPT within vessel 120. Through the use of the lag vessel 120 and its associated features, the concentration of contaminant material in lines 132, 136 may be reduced to about 40 PPT. Thus, the lag vessel 120 may reduce the concentration of contaminant material by at least approximately 98%. In other embodiments, the concentration may be at least approximately 95% lower or at least approximately 90% lower at lines 132, 136 as compared to the material in lag vessel 120. Cumulatively, the system may reduce the concentration of contaminant material in the effluent discharge material at line 136 (as compared to the material at line 108) by 99.96% (reducing the concentration by a factor of 25000) where two vessels are used. However, in other embodiments, three or more vessels may be used to further reduce the concentration of contaminant material.

FIG. 1B is a schematic view illustrating an apparatus 100′ with three vessels. The lead vessel 102 and the lag vessel 120 in FIG. 1B may have the same features as the lead vessel 102 and the lag vessel 120 of FIG. 1A. However, in FIG. 1B, a second lag vessel 156 (e.g., a polish vessel) is provided, and filtrate material from the lag vessel 120 may be transferred into the polish vessel 156 from the outlet of pump 134 via line 162.

Similar to the other vessels, the third vessel 156 may have a mixing impeller 158 with an associated motor 105C. A filter 160 may also be associated with the third vessel 156. To ensure that material does not clog the filter 160, air, water, or another fluid may be provided via line 161 (e.g., pulsed) to backwash material from the filter 160. Filtrate material passing through the filter 160 may flow through line 168 to a subsequent vessel or to the environment as effluent discharge material.

In some embodiments, a fresh supply of IX material may be provided to the third vessel 156 via line 164. For example, IX material may be injected only into the third vessel 156, and only recycled IX material is provided to the lag vessel 120 (via line 166) and to the lead vessel 102 (via line 128). However, in the embodiment illustrated in FIG. 1B, a fresh supply of IX material is also provided to lag vessel 120 via line 126. In other embodiments, a fresh supply of IX material may also be provided via an additional line at the lead vessel 102.

Where three or more vessels are utilized, the lead vessel would typically have a higher concentration of contaminants relative to the lag vessel, the polish vessel, and any subsequent vessels. The first lag vessel would typically have a higher concentration of contaminants than any subsequent vessels. Thus, the system continuously removes contaminants to accomplish successively lower concentrations. Any number of vessels can be used to ensure that the amount of contaminants within the effluent discharge material meets an effluent treatment goal.

In some embodiments, the sequential vessels 102, 120, 156 could be operated in a batch mode with relatively higher concentrations of the IX material. IX material may be provided so that the IX material accounts for approximately 10% by weight of the material in the lead vessel 102, approximately 10% by weight of the material in the lag vessel 120, and approximately 10% by weight of the material in the polish vessel 156. Rather than having the material in the vessels 102, 120, 156 mixed continuously, the material in the vessels 102, 120, 156 may be mixed for a specified time and then be allowed to settle. After the material has settled, filtrate may be pumped through the filters 106, 124, 160 to the next unit operation. This would potentially allow for more effective use of the filters 106, 124, 160 and prevent a high pressure differential from causing fouling at the filters 106, 124, 160. After numerous cycles of batches, the exhausted IX material may settle and may be removed for disposal via line 110 (this may be done with the assistance of an additional pump). Exhausted IX material be transported to containers 107 for safe disposal.

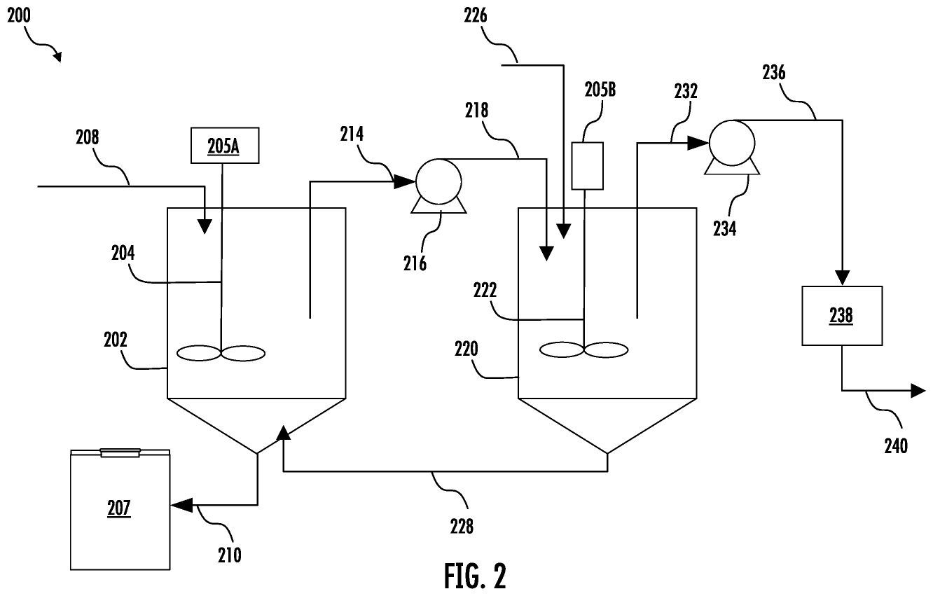

FIG. 2 is a diagrammatic representation illustrating another apparatus 200 in accordance with an embodiment of the present invention. In the apparatus 200, no filters are used, which may be beneficial to avoid any issues with fouling at filters. However, the apparatus 200 may be similar to the apparatus 100 of FIG. 1A in several respects. For example, the apparatus 200 may have a lead vessel 202 with a mixing impeller 204 driven by a motor 205A, and the lead vessel 202 may receive untreated liquid via line 208. The apparatus 200 may also have a lag vessel 220 with a mixing impeller 222 driven by a motor 205B, and the lag vessel 220 may receive a fresh supply of IX material via line 226. Additionally, exhausted IX material may be transported from the lead vessel 202 to containers 207 for safe disposal via line 210, and IX material may be recycled from the lag vessel 220 to the lead vessel 202 via line 228.

In the embodiment illustrated in FIG. 2, the apparatus 200 allows IX material to settle towards the bottom of the lead vessel 202, with other materials remaining or moving to higher levels. Material in the lead vessel 202 may be allowed to settle without the use of any interfering clarification aids. The material at higher levels may be extracted via the pump 216, urging the material through lines 214 and 218 to the lag vessel 220.

Similarly, at the lag vessel 220, IX material settles towards the bottom of the lag vessel 220, with other materials remaining or moving to higher levels. Material in the lag vessel 220 may be allowed to settle without the use of any interfering clarification aids. Material at higher levels of the lag vessel 220 may be extracted via the pump 234, urging the material through lines 232, 236, and 240. Additionally, a processing component 238 is provided downstream of pump 234 in this embodiment. Component 238 may, for example, include a clarifier and/or a sand filter. Where a clarifier is used, the clarifier may provide further chemical treatment. For example, an anionic polyacrylamide polymer flocculant may be utilized at component 238, and this may create floc with good settling capabilities.

Settled IX material in the lead vessel 202 may be re-mixed for continued operation or disposed via line 210, as necessary or desired. Settled IX material in the lag vessel 220 may be re-mixed for continued operation or recycled upstream via line 228, as necessary or desired.

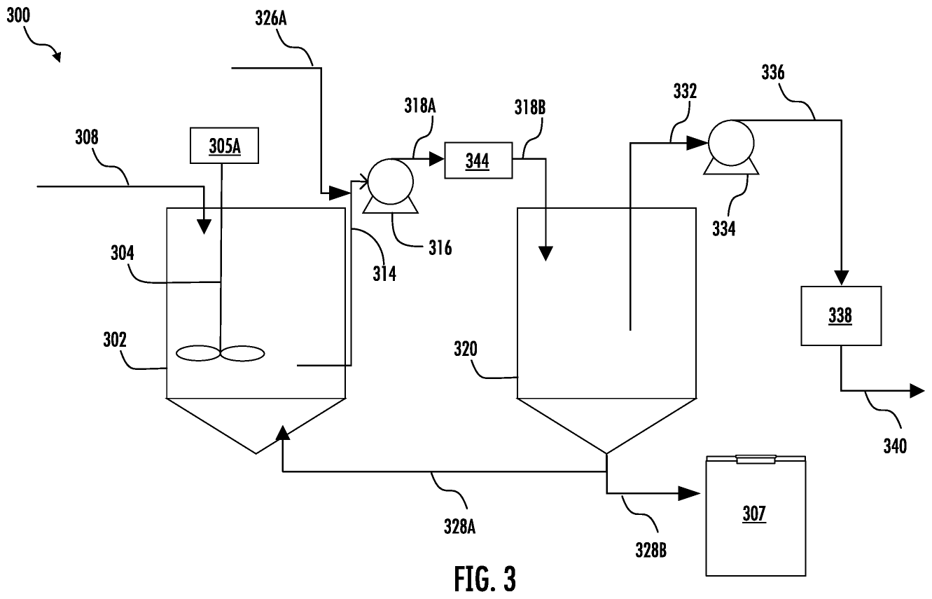

FIG. 3 is a diagrammatic representation of another apparatus 300 in accordance with an embodiment of the present invention. This apparatus 300 may share similarities with the systems discussed above. For example, similar to the other systems, a lead vessel 302 may be provided with a mixing impeller 304 driven by a motor 305A, and the lead vessel 302 may receive raw material containing contaminants via line 308. The lead vessel 302 may be a continuously stirred tank reactor, with the mixing impeller 304 being continuously active when the apparatus 300 is in use.

The apparatus 300 may also have a lag vessel 320. Rather than providing a fresh supply of IX material directly into the lag vessel 320, a fresh supply of IX material may in this case be provided via line 326A and inserted at line 314 near the inlet of pump 316. The pump 316 may thus urge both the material drawn from vessel 302 and the newly inserted IX material through line 318A to a mixer 344. Mixer 344 may mix the newly inserted IX material with fluid drawn from tank 302, with resultant mixed material being provided via line 318B to the lag vessel 320. In some embodiments, the mixer 344 may be a static mixer, and the mixer 344 may serve as a plug flow downstream reactor.

Additionally, lines 328A and 328B may be provided. Some portion of the settled material in the lag vessel 320 may be sent to the lead vessel 302 via line 328A, and the remaining portion of the settled material in the lag vessel 320 may be sent via line 328B to containers 307 for disposal.

Material at higher levels in the lag vessel 320 may be extracted via the pump 334, urging the material through lines 332, 336, and 340. An additional process component 338 may be provided for further separation of materials. The additional component 338 may include a filter and/or a clarifier in some embodiments. Effluent discharge material may then be provided via line 340.

Similar to embodiments described above, the concentration of contaminants may be significantly reduced in the effluent discharge material. For example, the raw material provided at line 308 may include contaminants at a concentration of approximately 100,000 PPT. The material provided at line 314 (upstream of the location where line 326A injects fresh IX material) may include contaminants at a concentration of approximately 2,000 PPT. Additionally, the material provided at line 332 may include contaminants at a concentration of approximately 40 PPT.

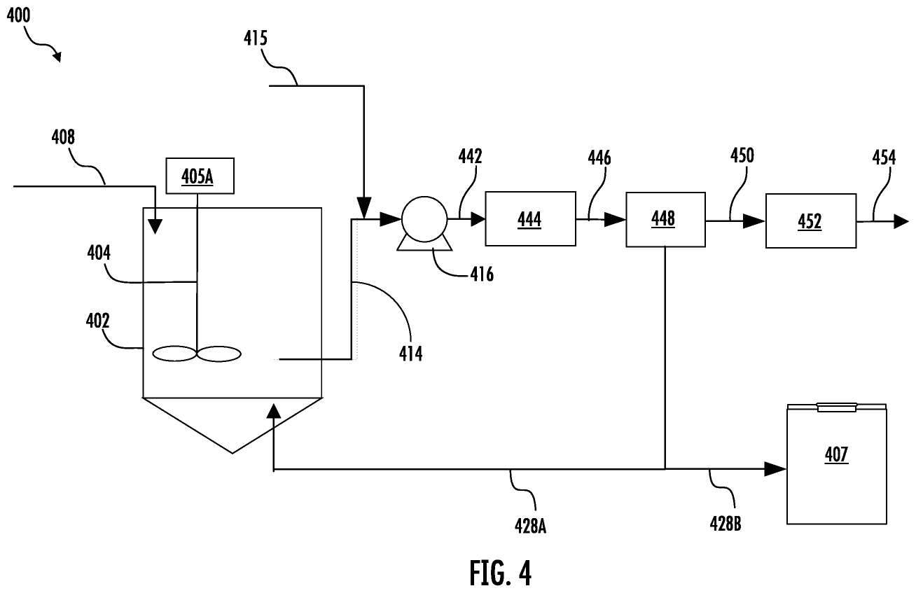

FIG. 4 is a diagrammatic representation of another apparatus 400 in accordance with an embodiment of the present invention. This apparatus 400 may share several similarities with previously described systems. For example, a lead vessel 402 may be provided that receives raw materials via line 408. A mixing impeller 404 may be provided that is driven by a motor 405A.

Similar to the apparatus 300, material at higher levels in the lead vessel 402 may be extracted via line 414. A fresh supply of IX material may be provided via line 415 and inserted into the system 400 at line 414. A pump 416 may urge material at line 414 through line 442 to a mixer 444, which may be similar to the mixer 344 discussed above.

A suitable separator 448 may be provided in the apparatus 400. Material may flow from the mixer 444 through line 446 to the separator 448. The separator 448 may be designed to separate the majority of the IX material from other material, thereby permitting IX material to be efficiently recycled to the lead vessel 402. In some embodiments, a centrifuge or a cyclone-inducing device may be used as a separator 448. Using such a device, IX and other material having higher densities may be separated from liquids and other materials having lower densities. In the present embodiment, for example, the separator may be a mesofluidic separator such as the Pacific Northwest National Lab Mesofluidic Separator or another similar separator. While the separator 448 is illustrated as being in a specific position in FIG. 4, the separator 448 may be provided in any suitable location within the apparatus 400 where further clarification is desired. Decontaminated material may be provided via line 450 to a filter 452, and the filtrate material exiting the filter 452 may exit the apparatus 400 via line 454 as effluent material.

Some portion of the remaining material from the separator 448 may be recycled to the lead vessel 402 via line 428A. Alternatively, or in addition, another portion of the remaining material may be sent to waste container 407 via line 428B. In some embodiments, the apparatus 400 may be configured so that approximately ninety percent of remaining material is transported to line 428A and approximately ten percent of remaining material is transported to line 428B. However, the apparatus 400 may be adjusted to distribute the remaining material differently, as necessary or desired.

In some embodiments, IX material may be provided in a bead form and in a powder form (as PIX material). For example, PIX material may be provided at a lag vessel (e.g. FIG. 1B, 120) and IX material may be provided in bead form at a polish vessel (e.g. FIG. 1B, 156) via an ion exchange column. In cases where bead IX material is used in at least one vessel, it may be advantageous to grind the used beads into PIX to allow for new and additional capacity. This would reduce the powder's material cost and remove a significant disposal cost from the bead's application.

Embodiments of the present invention may be utilized in a variety of ways to remove contaminants from base materials. For example, certain embodiments may be utilized in municipal wastewater treatment facilities or in drinking water treatment plants. In these systems, IX material may be injected upstream of a clarifier and may be mixed in the clarifier. IX material may be removed from the clarifier alongside other sludge in the clarifier and disposed safely in containers. Various embodiments may be incorporated as a primary, secondary, or tertiary treatment. The amount of contamination removal may be adjusted to treat the materials without bulk demineralization of the materials.

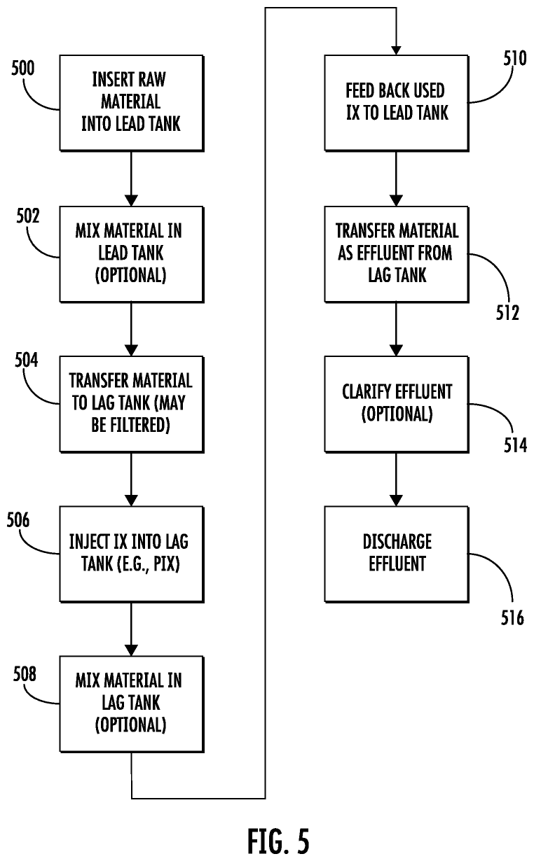

Certain aspects of the present invention may be easily understood with reference to FIG. 5. As indicated at 500, raw material in the form of untreated water having PFAS is inserted into a lead tank. Optionally, as indicated at 502, the material in the lead tank may be mixed. As indicated at 504, material in the lead tank is then transferred to a lag tank. In this regard, the material may be filtered en route to the lag tank. As indicated at 506, IX material (e.g., PIX in a slurry) may be injected into the lag tank. Optionally, as indicated at 508, the material in the lag tank may be mixed.

As indicated at 510, used IX material in the lag tank may be fed back to the lead tank so that there is some quantity of IX material in both tanks. In addition, as indicated at 512, effluent material is also transferred out of the lag tank. In some embodiments, one or more additional lag tanks may be provided downstream of the first lag tank, as necessary or desired. The effluent may optionally be filtered, clarified, and/or separated (as indicated at 514) and discharged (as indicated at 516) as clean water.

### EXAMPLE

A pilot unit was designed and built to allow for maximum flexibility in testing PFAS selective powder ion exchange. A two-vessel system similar to that illustrated in FIG. 1A was built for lead/lag operation. Each vessel was equipped with backwashable cartridge filters to retain the powder after being mixed in the vessels. The fresh powder from the lag vessel is able to be recycled into the lead vessel. The unit was built onto a single skid.

A first pilot testing was run at a drinking water site. The goal was to show the PFAS selective powder IX was able to bring the influent water down to below a level of 20 ng/L for six designated PFAS compounds (PFDA, PFHPA, PFHxS, PFNA, PFOS, and PFOA). The starting concentration of the water varied from 70-100 ng/L PFAS. All tests were done in batch mode.

“Recycled” refers to the powder that was first used in the lag vessel, and then transferred to the lead vessel for a second use. This would be similar to a carousel process of moving the lag column into the lead position once the lead was fully exhausted. “5 times Used” refer to the same powder being used in the same vessel for 5 batches. A batch was processed, filtered, and then the powder backwashed into the same vessel for a 2^{nd}, 3^{rd}, etc. number of batches. This allowed a high concentration of powder (good powder/liquid contact) while decreasing the total mass of powder used over all the batches. Results are shown in Table 1.

TABLE 1

| Powder | | Lead Vessel | Lag Vessel | Mix |
|---|---|---|---|---|
| Concentration | Lead/Lag | (Mass6 | (Mass6 | Time |
| in each Vessel | Powder State | PFAS ng/L) | PFAS ng/L) | (minutes) |
| 5 mg/L | Fresh/Fresh | 58 | 11 | 3 |
| 15 mg/L | Fresh/Fresh | 37 | 11 | 1 |
| 15 mg/L | Fresh/Fresh | 37 | 13 | 3 |
| 15 mg/L | Fresh/Fresh | 29 | 3 | 10 |
| 30 mg/L | Fresh/Fresh | 15 | 3 | 3 |
| 50 mg/L | Fresh/Fresh | 7 | 0 | 10 |
| 50 mg/L | Fresh/Fresh | 6 | 0 | 3 |
| 75 mg/L | 5 times | 9 | 5 | 3 |
| | Used/Used | | | |
| 15 mg/L | Recycled/Fresh | 27 | 2 | 3 |
| 30 mg/L | Recycled/Fresh | 8 | 0 | 3 |
| 50 mg/L | Recycled/Fresh | 5 | 0 | 3 |

A second pilot was run at a contaminated well water drinking site. The goal was to test the system with a different water quality, with a much higher starting PFAS concentration value. The starting concentration of the water varied from 1300-1500 ng/L PFAS. With the exception of the last three tests, all were done in batch mode. The last 3 tests were done on a continuous basis for 20 vessel volumes with the powder being continuously fed.

TABLE 2

| Powder | | | | | Mix |
|---|---|---|---|---|---|
| Concentration | | Lead/Lag | Lead Vessel | Lag Vessel | Time |
| in each Vessel | | Powder State | (ng/L) | (ng/L) | (minutes) |
| 10 | mg/L | Fresh/Fresh | 290 | 8 | 3 |
| 30 | mg/L | Fresh/Fresh | 69 | 5 | 3 |
| 30 | mg/L | Fresh/Fresh | 37 | 3 | 10 |
| 50 | mg/L | Fresh/Fresh | 56 | 4 | 1 |
| 50 | mg/L | Fresh/Fresh | 24 | 5 | 3 |
| 100 | mg/L | Fresh/Fresh | 23 | 3 | 3 |
| 200 | mg/L | Fresh/Fresh | 5 | 2 | 3 |
| 75 | mg/L | 7 times | 68 | 3 | 3 |
| | | Used/Used | | | |
| 30 | mg/L | Recycled/Fresh | 94 | 5 | 3 |
| 50 | mg/L | Recycled/Fresh | 40 | 5 | 3 |
| 30 | mg/L | Fresh/Fresh** | 42 | 10 | 3 |
| 30 | mg/L | Fresh/Fresh** | 29 | 5 | 10 |
| 100 | mg/L | Fresh/Fresh** | 16 | 3 | 10 |

**Both lead & lag powders were continuously fed during the last 3 tests.

The testing confirmed that, as expected, very low discharge limits can be achieved by doing multi-stage treatment or increasing powder concentration. In addition, recycling powdered IX was found to work well. The powder IX resin has such a high ultimate capacity that it can be recycled very effectively and still remove the bulk of the contaminants. Moreover, re-using the powder many times with a higher starting concentration seems very effective. The higher powder/liquid contact available makes for better removal rates. It can also be surmised that the mix times do not seem to have a large effect when the powder or contaminant concentrations are high. Typically, only at lower powder or contaminant concentrations, more time may give noticeably better results. Additionally, continuous operation (not just batch mode) did very well and confirms the applicability to full scale systems.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. An apparatus for treating water including PFAS, said apparatus comprising:
influent piping adapted to conduct untreated water from an untreated water source;
a first process vessel fluidly coupled to said influent piping to receive said untreated water;
first transfer piping adapted to conduct first vessel processed water from said first process vessel;
a second process vessel coupled to said first transfer piping to receive said first vessel processed water;
an ion exchange injection mechanism adapted to supply ion exchange (IX) material to said second process vessel; and
second transfer piping adapted to conduct second vessel processed water from said second process vessel.

2. An apparatus as set forth in claim 1, further comprising feedback piping adapted to supply used ion exchange material from said second process vessel to said first process vessel.

3. An apparatus as set forth in claim 1, wherein said ion exchange injection mechanism injects powder ion exchange material into the second process vessel.

4. An apparatus as set forth in claim 1, wherein said ion exchange injection mechanism injects bead ion exchange material into the second process vessel.

5. An apparatus as set forth in claim 1, wherein at least one of the first process vessel and the second process vessel includes a mixing mechanism.

6. An apparatus as set forth in claim 1, further comprising a separator located along said second transfer piping downstream of said second process vessel.

7. An apparatus as set forth in claim 1, further comprising IX discharge piping fluidly coupled to said first process vessel to facilitate removal of spent IX material therefrom.

8. An apparatus as set forth in claim 1, further comprising a third process vessel fluidly coupled to said second transfer piping downstream of said second process vessel.

9. An apparatus as set forth in claim 1, wherein said ion exchange injection mechanism is adapted to introduce ion exchange material into the first transfer piping.

10. An apparatus as set forth in claim 1, further comprising first and second filters associated with said first transfer piping and said second transfer piping, respectively.

11. An apparatus for treating water including PFAS, said apparatus comprising:
influent piping adapted to conduct untreated water from an untreated water source;
a first process vessel fluidly coupled to said influent piping to receive said untreated water;
first transfer piping adapted to conduct first vessel processed water from said first process vessel;
a second process vessel coupled to said first transfer piping to receive said first vessel processed water;
an ion exchange injection mechanism adapted to supply ion exchange (IX) material to said second process vessel;
second transfer piping adapted to conduct second vessel processed water from said second process vessel;
feedback piping adapted to supply used ion exchange material from said second process vessel to said first process vessel; and
wherein at least one of the first process vessel and the second process vessel includes a mixing mechanism.

12. An apparatus as set forth in claim 11, wherein said ion exchange injection mechanism injects powder ion exchange material into the second process vessel.

13. An apparatus as set forth in claim 11, wherein said ion exchange injection mechanism injects bead ion exchange material into the second process vessel.

14. An apparatus as set forth in claim 11, further comprising a separator located along said second transfer piping downstream of said second process vessel.

15. An apparatus as set forth in claim 11, further comprising IX discharge piping fluidly coupled to said first process vessel to facilitate removal of spent IX material therefrom.

16. An apparatus as set forth in claim 11, further comprising a third process vessel fluidly coupled to said second transfer piping downstream of said second process vessel.

17. An apparatus as set forth in claim 11, wherein said ion exchange injection mechanism is adapted to introduce ion exchange material into the first transfer piping.

18. An apparatus as set forth in claim 11, further comprising first and second filters associated with said first transfer piping and said second transfer piping, respectively.

19. A method of treating liquid containing PFAS, said method comprising steps of:
(a) feeding untreated liquid into a first process vessel;
(b) processing said untreated liquid via first vessel IX material in said first process vessel to produce first vessel processed liquid;
(c) transferring said first vessel processed liquid from said first process vessel to a second process vessel;
(d) processing said first vessel processed liquid via second vessel IX material in said second process vessel to produce second vessel processed liquid;
(e) recycling at least a portion of said second vessel IX material to said first process vessel so as to contribute to said first vessel IX material; and
(f) transferring said second vessel processed liquid from said second process vessel.

20. A method as set forth in claim 19, further comprising the step of injecting fresh IX material into said second process vessel.

21. A method as set forth in claim 20, wherein said fresh IX material is injected into piping upstream of said second process vessel.

22. A method as set forth in claim 21, wherein said first vessel treated liquid is passed through a static mixer en route to said second process vessel after injection of said fresh IX material.

23. A method as set forth in claim 20, wherein said fresh IX material comprises powdered form IX material.

24. A method as set forth in claim 19, wherein at least one of said first vessel processed liquid and said second vessel processed liquid is filtered.

25. A method as set forth in claim 19, wherein processing of said untreated liquid in said first process vessel involves mixing.

26. A method as set forth in claim 25, wherein processing of said first vessel processed liquid in said second process vessel involves mixing.

27. A method as set forth in claim 19, wherein said second vessel processed liquid is passed through at least one of a filter, a clarifier, and a separator.

28. A method as set forth in claim 19, wherein said second vessel processed liquid is discharged.

29. A method as set forth in claim 19, wherein said second vessel processed liquid is transferred from said second process vessel to a third process vessel, further comprising the step of processing said second vessel processed liquid via third vessel IX material in said third process vessel to produce third vessel processed liquid.
